(19) United States
(12) Patent Application Publication
(10) Pub. No.: US 2026/0316356 A1
(43) Pub. Date: Oct. 15, 2026

(54) MOLD AND METHOD OF MANUFACTURING CHASSIS

(71) Applicants: MICRO-STAR INT’L CO., LTD., New Taipei City (TW); MSI ELECTRONIC (KUN SHAN) CO., LTD., Suzhou City (CN)

(72) Inventors: Chih-Hung CHANG, New Taipei City (TW); Ying Yu CHEN, Taipei City (TW)

(73) Assignees: MICRO-STAR INT’L CO., LTD., New Taipei City (TW); MSI ELECTRONIC (KUN SHAN) CO., LTD., Suzhou City (CN)

(21) Appl. No.: 19/203,368

(22) Filed: May 9, 2025

(30) Foreign Application Priority Data
Apr. 11, 2025 (TW) 114113777

(51) Int. Cl. B29C 45/26; B29L 31/34

(52) U.S. Cl. CPC B29C 45/2628; B29C 2793/0027; B29C 2793/009; B29L 2031/3481

(57) ABSTRACT

A mold includes a male portion and a female portion. The male portion has a core. The female portion is disposed on the male portion, and has an injection opening. A molding space is formed between the male portion and the female portion. The injection opening is connected to the molding space, and is configured for a plastic material to be injected into the molding space. The plastic material can be molded as the chassis. The core is located in the molding space, and corresponds to the injection opening. The core is configured to correspond to a screw hole which is formed after the chassis is demolded. After injecting the plastic material through the injection opening to form the chassis, a portion of the chassis corresponding to the injection opening is cut off. The portion of the chassis is formed as an accommodating recess connected to the screw hole.

### CROSS-REFERENCE TO RELATED APPLICATIONS

This non-provisional application claims priority under 35 U.S.C. § 119(a) on Patent Application No(s). 114113777 filed in Taiwan, R.O.C. on April 11, 2025, the entire contents of which are hereby incorporated by reference.

### TECHNICAL FIELD

The present disclosure relates to a mold and a method of manufacturing chassis more particularly to a mold and a method of manufacturing chassis in which a screw hole thereof corresponds to an injection opening for molding.

### BACKGROUND

With the development of modern society and advances in science and technology, demands for electronic devices such as consumer electronic products, computers, and daily necessities are increasing. The aforementioned products are currently designed with an emphasis on being lightweight and slim. For example, the casings of the aforementioned products are usually made of plastic material.

Generally, the aforementioned products are formed by injecting plastic into a mold using either a sprue-less injection method or an injection molding method. However, recessed traces configured for injection can be formed at the surfaces of the products through the conventional sprue-less injection method. Thus, it may require to apply auxiliary materials or decorative patterns on the surfaces of the products for aesthetically-pleasing appearance. In addition, the conventional injection molding method can result in ring-shaped flow traces on the surfaces of the products due to the flow of the plastic material, thereby adversely affecting the aesthetic appearance of the products. Therefore, how to avoid a formation of recessed traces or flow traces after molding so as to maintain the aesthetic appearance of the products is one of the key issues that developers need to address.

### SUMMARY

The present disclosure provides a mold and a method of manufacturing chassis so as to avoid a formation of recessed traces or flow traces after molding so as to maintain the aesthetic appearance of a chassis.

One embodiment of the present disclosure provides a mold configured for manufacturing a chassis. The mold includes a male portion and a female portion. The male portion has at least one core. The female portion is disposed on the male portion, and has at least one injection opening. A molding space is formed between the male portion and the female portion. The at least one injection opening is connected to the molding space. The at least one injection opening is configured for a plastic material to be injected into the molding space. The plastic material can be molded as the chassis. The at least one core is located in the molding space. The at least one core corresponds to the at least one injection opening. The at least one core is configured to correspond to at least one screw hole which is formed in the chassis after the chassis is demolded from the male portion and the female portion. After injecting the plastic material through the at least one injection opening to form the chassis, a portion of the chassis corresponding to the at least one injection opening is cut off. Then, the portion of the chassis can be formed as at least one accommodating recess connected to the at least one screw hole. A diameter of the at least one screw hole is less than a diameter of the at least one accommodating recess.

Another embodiment of the present disclosure provides a method of manufacturing chassis including assembling a male portion and a female portion to form a molding space between the male portion and the female portion, injecting a plastic material into the molding space from at least one injection opening of the female portion to form a chassis within the molding space, and cutting off a portion of the chassis corresponding to the at least one injection opening to form at least one accommodating recess. At least one core of the male portion corresponds to the at least one injection opening and at least one screw hole which is formed in the chassis after the chassis is demolded from the male portion and the female portion. The at least one accommodating recess is connected to the at least one screw hole. A diameter of the at least one screw hole is less than a diameter of the at least one accommodating recess.

According to the mold and the method of manufacturing chassis disclosed by the above embodiments, the at least one core of the mold corresponds to the at least one injection opening configured for the plastic material to be injected into the molding space, and the at least one injection opening can correspond to the at least one screw hole of the finished chassis. That is, a position of the at least one injection opening can be configured as a position of the at least one screw hole of the chassis. Therefore, the presence of the at least one core can assist in generating a disturbance when injecting the plastic material into the molding space, so that a formation of ring-shaped flow traces on the chassis can be reduced. In addition, the plastic material is injected directly through the at least one injection opening configured as the at least one screw hole of the finished chassis without addition injection openings. Accordingly, the aesthetic appearance of the finished chassis can be maintained without additional auxiliary materials to cover up molding traces.

In addition, as mentioned above, the position of the at least one injection opening can be configured as the position of the at least one screw hole of the chassis. Therefore, the times of mold trials for the mold can be reduced, and the time required to adjust injection molding parameters can be shortened. Moreover, even if traces occur due to shrinkage of the at least one injection opening during the injection molding process, such traces can be removed by machining the area of the at least one injection opening into the at least one screw hole through cutting off a sprue formed by the plastic material. Accordingly, the adverse effect on the aesthetic appearance of the finished chassis can be prevented.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a perspective view of a mold in accordance with the first embodiment of the present disclosure;

FIG. 2 is an exploded view of the mold in FIG. 1;

FIG. 3 is a cross-sectional view of the mold in FIG. 1;

FIG. 4 is a mold flow analysis performed prior to manufacturing a chassis through a conventional mold;

FIG. 5 is a mold flow analysis performed prior to manufacturing a chassis through the mold in FIG. 1;

FIG. 6 is a cross-sectional view showing that a plastic material has not injected into the mold in FIG. 1 yet;

FIG. 7 is a top view showing that the plastic material is injected into the mold in FIG. 1;

FIG. 8 is a cross-sectional view showing that the plastic material is injected into the mold in FIG. 1;

FIG. 9 is a partial and enlarged perspective view showing that the chassis has been manufactured through the mold in FIG. 1 and sprue formed by the plastic material has not been removed yet;

FIG. 10 is a cross-sectional view showing that the chassis has been manufactured through the mold in FIG. 1 and the sprue formed by the plastic material has not been removed yet;

FIG. 11 is a partial and enlarged perspective view showing that the chassis has been manufactured through the mold in FIG. 1 and the sprue formed by the plastic material has been removed;

FIG. 12 is a cross-sectional view showing that the chassis has been manufactured through the mold in FIG. 1 and the sprue formed by the plastic material has been removed; and

FIG. 13 is a flow chart showing a method to manufacture the chassis through the mold in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

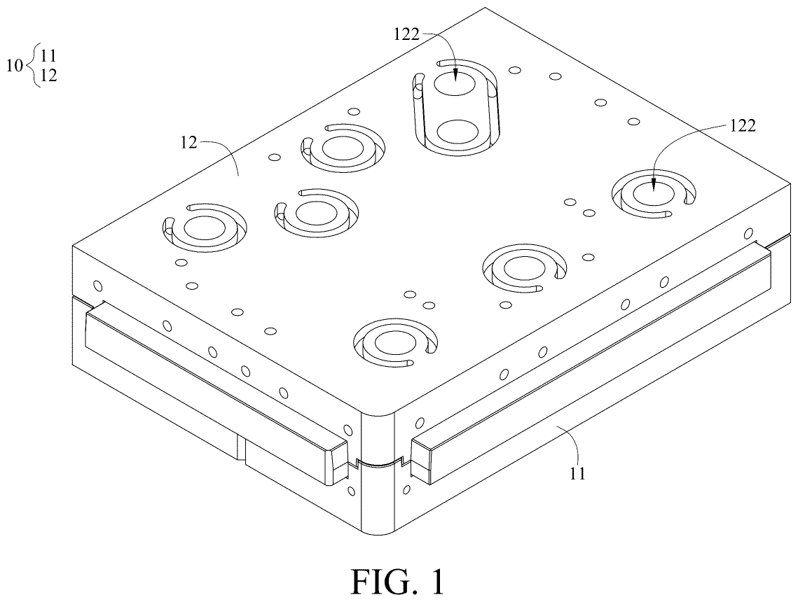

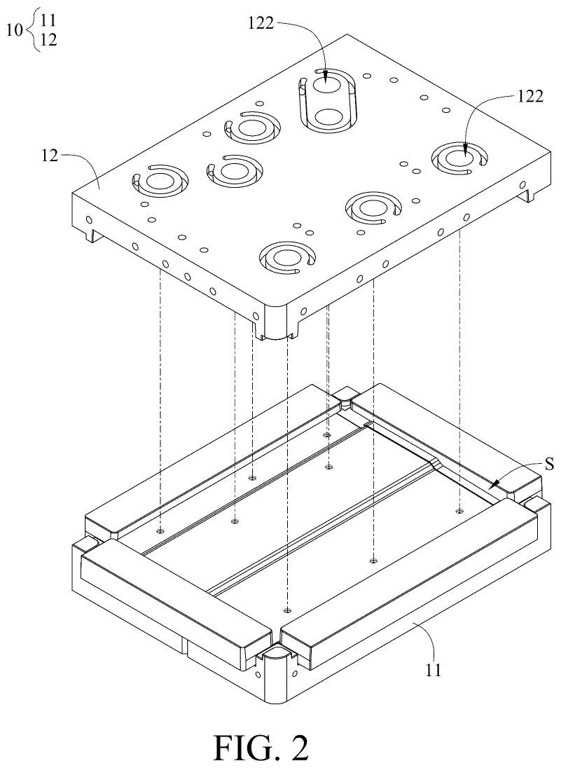

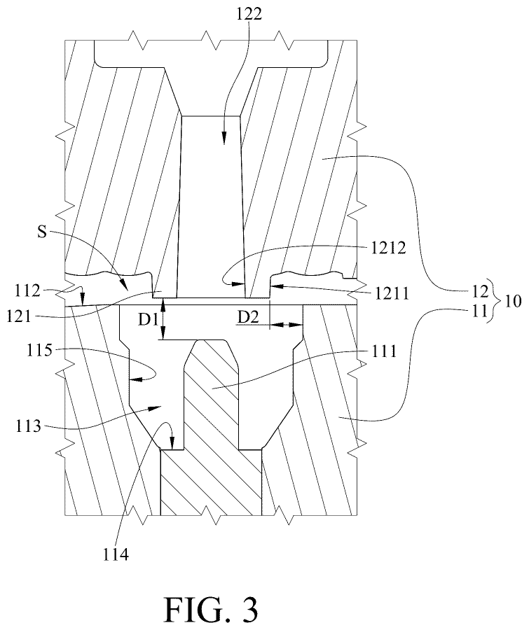

Please refer to FIG. 1 to FIG. 3, where FIG. 1 is a perspective view of a mold 10 in accordance with the first embodiment of the present disclosure, FIG. 2 is an exploded view of the mold 10 in FIG. 1, and FIG. 3 is a cross-sectional view of the mold 10 in FIG. 1.

In this embodiment, the mold 10 is configured for manufacturing a chassis (not shown). The chassis is, for example, a casing of a laptop computer, but the present disclosure is not limit thereto. The mold 10 includes a male portion 11 and a female portion 12. The male portion 11 has a plurality of cores 111. The female portion 12 is disposed on the male portion 11. In detail, the male portion 11 has a flat surface 112, a plurality of recess portions 113, a plurality of bottom surfaces 114 and a plurality of surrounding surfaces 115. The flat surface 112 faces the female portion 12.

In this embodiment, structures of the cores 111 are the same, structures of the recess portions 113 are the same, structures of the bottom surfaces 114 are the same, and structures of the surrounding surfaces 115 are the same. Therefore, only one core 111, one recess portion 113, one bottom surface 114 and one surrounding surface 115 will be described below. The recess portion 113 recesses inwardly from the flat surface 112. The bottom surface 114 and the surrounding surface 115 together surround the recess portion 113. The flat surface 112 and the bottom surface 114 are respectively connected to two opposite sides of the surrounding surface 115. The core 111 protrudes from the bottom surface 114, and the core 111 is spaced apart from the surrounding surface 115.

The female portion 12 has a plurality of protrusions 121 and a plurality of injection openings 122. In this embodiment, structures of the protrusions 121 are the same, and structures of the injection openings 122 are the same. Therefore, only one protrusion 121 and one injection opening 122 will be described below. The protrusion 121 is located at the injection opening 122, and extends toward the male portion 11. That is, a structure of a portion located at the injection opening 122 of the female portion 12 is designed to extend down toward the male portion 11. The injection opening 122 penetrates through the protrusion 121. A height of the protrusion 121 (i.e. a recessing depth) is, for example, 1 millimeter.

A molding space S is formed between the male portion 11 and the female portion 12. The recess portion 113 forms a part of the molding space S. The injection opening 122 is in fluid communication with the molding space S. The injection opening 122 is configured for a plastic material (not shown) to be injected into the molding space S, such that the plastic material can be molded as the chassis. A diameter of the injection opening 122 is, for example, 6 millimeters. The core 111 is located in the molding space S. Accordingly, a disturbance can be generated in the plastic material during the injection molding process to reduce a formation of, for example, ring-shaped flow traces on the chassis.

The core 111 corresponds to the injection opening 122, and the core 111 is configured to correspond to a screw hole which is formed in the chassis after the chassis is demolded from the male portion 11 and the female portion 12. That is, after the chassis is formed and the male portion 11 and the female portion 12 are removed, a space in which the core 111 is originally disposed is configured as the screw hole of the chassis.

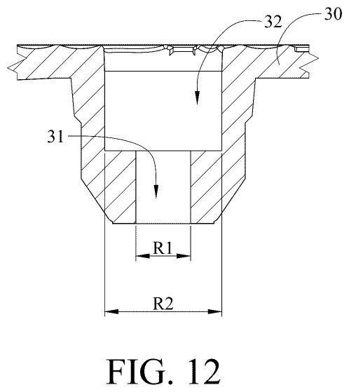

Please refer to FIG. 12 with reference of FIG. 1 to FIG. 3, where FIG. 12 is a cross-sectional view showing that the chassis 30 has been manufactured through the mold 10 in FIG. 1 and the sprue formed by the plastic material has been removed. In this embodiment, after injecting the plastic material through the injection opening 122 to form the chassis 30, a portion of the chassis 30 corresponding to the injection opening 122 is cut off, so that such portion can be formed as an accommodating recess 32 connected to the screw hole 31. Accordingly, a screw (not shown) can be placed along a direction from the accommodating recess 32 to the screw hole 31, and the accommodating recess 32 can accommodate, for example, a screw head of the screw. A diameter R1 of the screw hole 31 is, for example, less than a diameter R2 of the accommodating recess 32.

Please refer to FIG. 3 again. In this embodiment, a distance D1 between the core 111 and the female portion 12 is, for example, equal to an average distance between the male portion 11 and the female portion 12. The so-called “average distance” refers to a thickness of a chassis which can be formed. Furthermore, the distance D1 between the core 111 and the protrusions 121 of the female portion 12 can meet a specification of the average distance between the male portion 11 and the female portion 12. In an example, the distance D1 is equal to the average distance between the male portion 11 and the female portion 12. Accordingly, the injection opening 122 can be prevented from shrinking if the distance D1 between the core 111 and the female portion 12 is too long, which prevents adverse effect on the appearance of the finished chassis. In addition, the plastic material can be prevented from failing to form the finished chassis if the distance D1 between the core 111 and the female portion 12 is too short. In an example, the distance D1 between the core 111 and the protrusions 121 of the female portion 12 is, for example, 1.5 millimeters. Furthermore, the distance D1 between the core 111 and the protrusions 121 of the female portion 12 is, for example, greater than or equal to 1.2 millimeters.

In this embodiment, the protrusion 121 has a first side surface 1211 and a second side surface 1212 facing away from each other. The first side surface 1211 faces away from the injection opening 122. A maximum distance D2 between the first side surface 1211 and the surrounding surface 115 can meet a specification of the average distance between the male portion 11 and the female portion 12. In an example, the maximum distance D2 is equal to the average distance between the male portion 11 and the female portion 12. Accordingly, the injection opening 122 can be prevented from shrinking if the maximum distance D2 between the first side surface 1211 and the surrounding surface 115 is too long, which prevents adverse effect on the appearance of the finished chassis. In addition, the plastic material can be prevented from failing to form the finished chassis if the maximum distance D2 between the first side surface 1211 and the surrounding surface 115 is too short. For example, the maximum distance D2 between the first side surface 1211 and the surrounding surface 115 is, for example, 1.5 millimeters. Furthermore, the maximum distance D2 between the first side surface 1211 and the surrounding surface 115 is, for example, greater than or equal to 1.2 millimeters.

In this embodiment, as mentioned above, the core 111 of the mold 10 corresponds to the injection opening 122 configured for the plastic material to be injected into the molding space S, and the injection opening 122 can correspond to the screw hole of the finished chassis. That is, a position of the injection opening 122 can be configured as a position of the screw hole of the chassis. Therefore, the presence of the core 111 can assist in generating a disturbance when injecting the plastic material into the molding space S, so that the formation of ring-shaped flow traces on the chassis can be reduced. In addition, the plastic material is injected directly through the injection opening 122 configured as the screw hole of the finished chassis without addition injection openings. Accordingly, the aesthetic appearance of the finished chassis can be maintained without additional auxiliary materials to cover up molding traces.

In addition, as mentioned above, the position of the injection opening 122 can be configured as the position of the screw hole of the chassis. Therefore, the times of mold trials for the mold 10 can be reduced, and the time required to adjust injection molding parameters can be shortened. Moreover, even if traces occur due to shrinkage of the injection opening 122 during the injection molding process, such traces can be removed by machining the area of the injection opening 122 into the screw hole through cutting off the sprue formed by the plastic material. Accordingly, the adverse effect on the aesthetic appearance of the finished chassis can be prevented.

In this embodiment, there are multiple cores 111, multiple recess portions 113, multiple bottom surfaces 114, multiple surrounding surfaces 115, multiple protrusions 121 and multiple injection openings 122, but the present disclosure is not limit thereto. In other embodiment, there may be one core, one recess portion, one bottom surface, one surrounding surface, one protrusion and one injection opening merely.

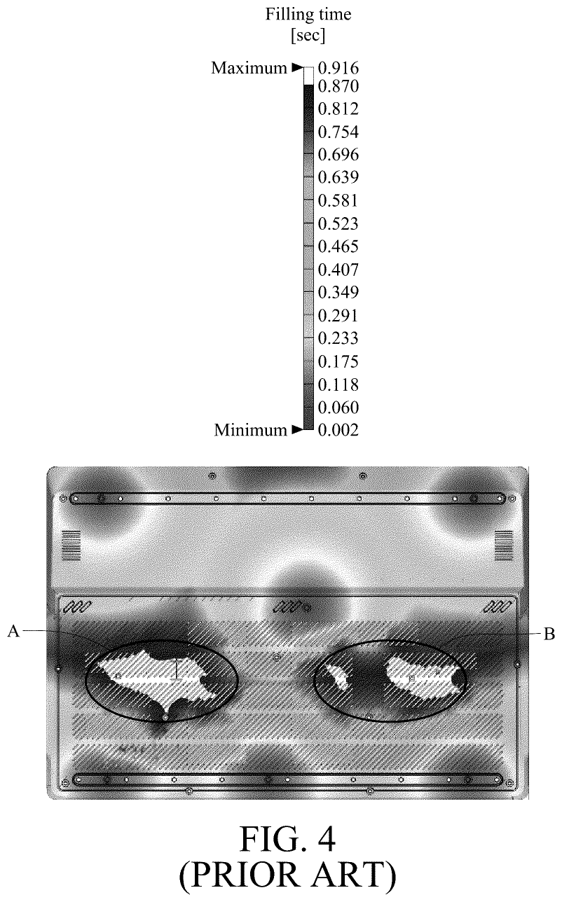

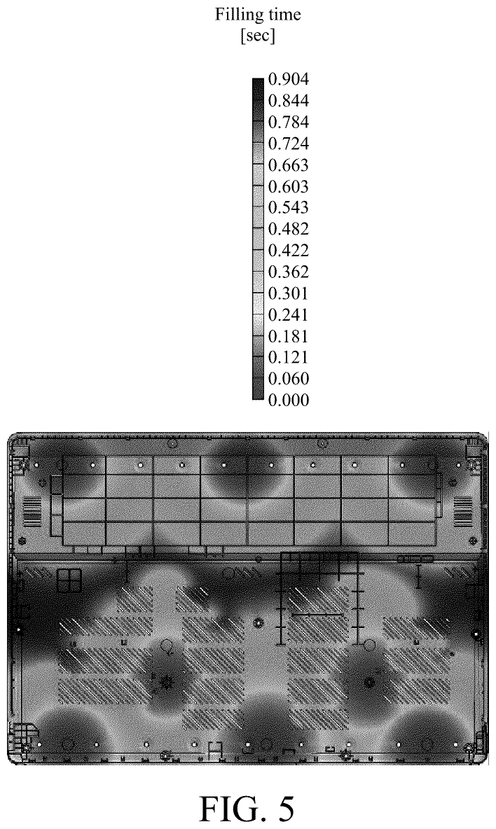

Please refer to FIG. 4 and FIG. 5, where FIG. 4 is a mold flow analysis performed prior to manufacturing a chassis through a conventional mold, and FIG. 5 is a mold flow analysis performed prior to manufacturing a chassis through the mold 10 in FIG. 1.

Generally, before arranging the mold 10 to manufacture the chassis, the manufacturer may conduct a mold flow analysis to evaluate the filling condition of the plastic material during the injection molding process. As shown in FIG. 4, when the chassis is manufactured through a conventional mold, the plastic material may be difficult to be filled in areas A1 and A2 of air outlets of the finished chassis, or the plastic material may be lack in the areas A1 and A2. Therefore, the manufacturing process of the chassis may be adversely affected. As shown in FIG. 5, in the mold 10 of this embodiment, the additional injection openings 122, as shown in FIG. 1 to FIG. 3, are disposed near the air outlets of the finished chassis to fill the plastic material therethrough, thereby facilitating the plastic material to be fully filled in the mold 10 during the injection molding process.

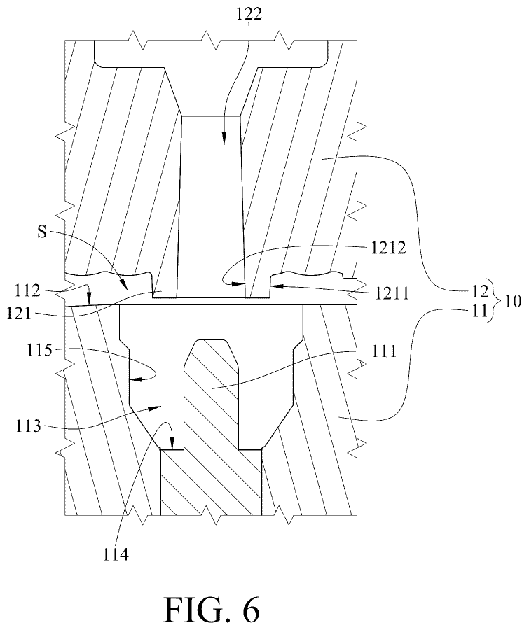

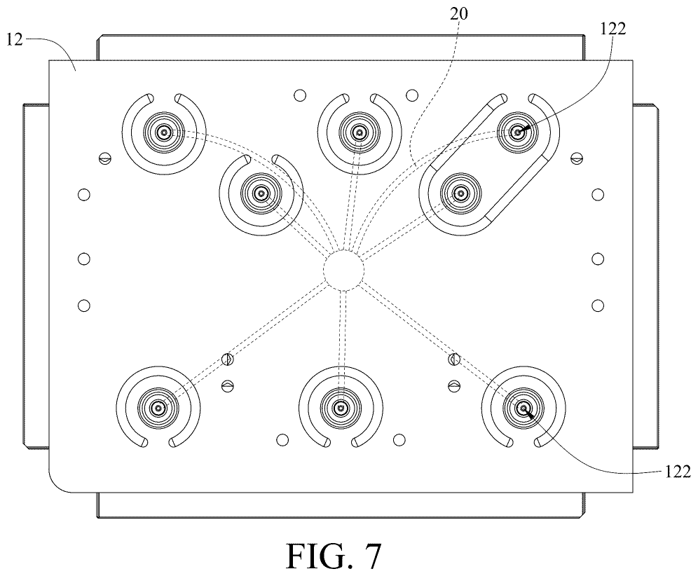

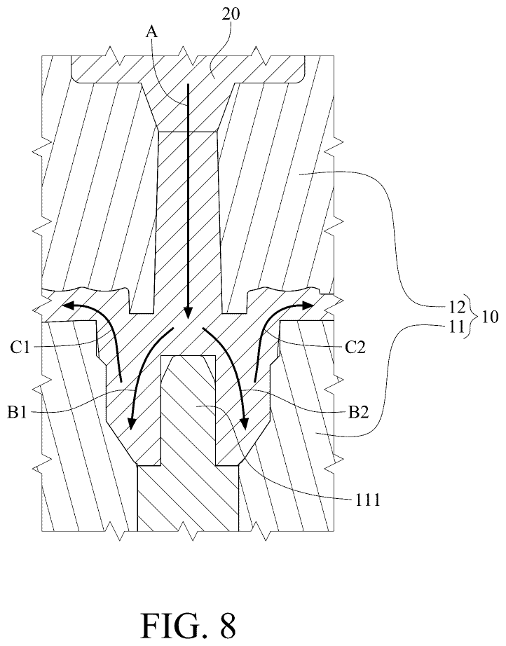

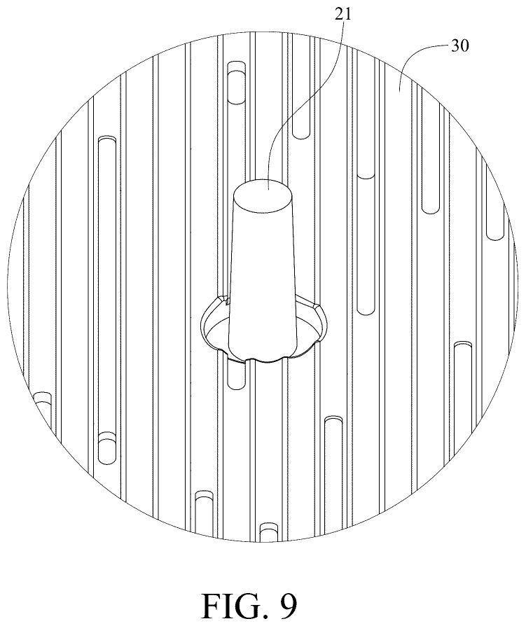

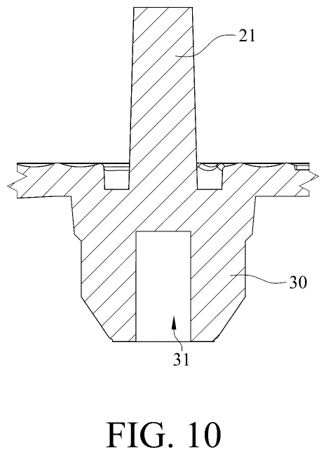

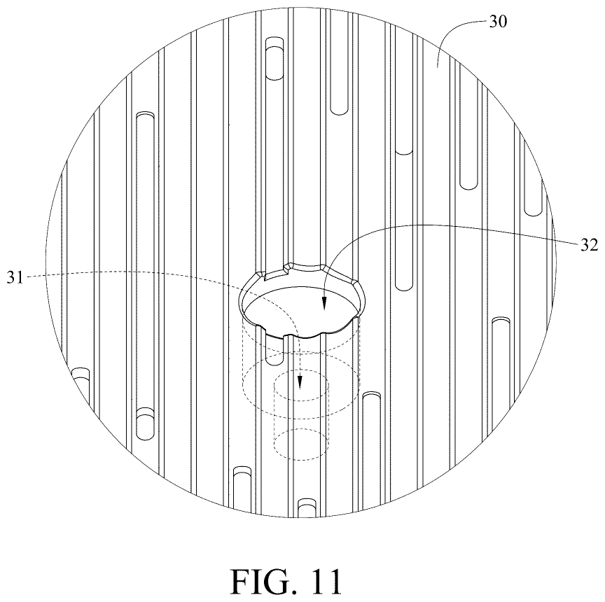

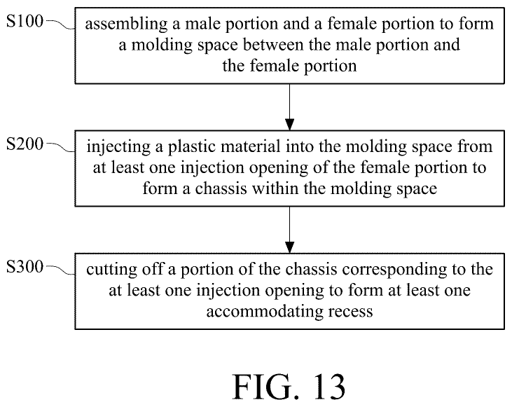

Please refer to FIG. 6 and FIG. 13, where FIG. 6 is a cross-sectional view showing that the plastic material 20 has not injected into the mold 10 in FIG. 1 yet, FIG. 7 is a top view showing that the plastic material 20 is injected into the mold 10 in FIG. 1, FIG. 8 is a cross-sectional view showing that the plastic material 20 is injected into the mold 10 in FIG. 1, FIG. 9 is a partial and enlarged perspective view showing that the chassis 30 has been manufactured through the mold 10 in FIG. 1 and sprue 21 formed by the plastic material 20 has not been removed yet, FIG. 10 is a cross-sectional view showing that the chassis 30 has been manufactured through the mold in 10 FIG. 1 and the sprue 21 formed by the plastic material 20 has not been removed yet, FIG. 11 is a partial and enlarged perspective view showing that the chassis 30 has been manufactured through the mold 10 in FIG. 1 and the sprue 21 formed by the plastic material 20 has been removed, and FIG. 13 is a flow chart showing a method to manufacture the chassis 30 through the mold 10 in FIG. 1.

After the mold flow analysis is performed, the chassis 30 can be manufactures through the mold 10. The manufacturing method of the chassis 30 according to this embodiment includes following steps. As shown in FIG. 6 and FIG. 13, a step S100 is, firstly, performed to assemble the male portion 11 and the female portion 12 to form the molding space S therebetween.

A step S200 is, as shown in FIG. 7, performed to inject a plastic material 20 into the molding space S from the injection opening 122 of the female portion 12 to form the chassis 30 within the molding space S. In detail, as shown in FIG. 8, the plastic material 20 is injected into the molding space S from the injection opening 122 along a direction A. Then, the plastic material 20 generates the disturbance along directions B1 and B2 to be filled in the molding space S. Then, the plastic material 20 flows back along directions C1 and C2 to be fully filled in the molding space S. Accordingly, the formation of ring-shaped flow traces on the finished chassis 30 can be reduced through the aforementioned filling manner, thereby maintaining the aesthetic appearance of the finished chassis 30.

As shown in FIG. 9 and FIG. 10, after the plastic material 20 is completely filled into the molding space S through the injection molding process, the plastic material 20 can be molded as the chassis 30, and the male portion 11 and the female portion 12 can be removed. The space in which the core 111 of the male portion 11 is originally disposed is configured as the screw hole 31 of the chassis 30, and the sprue 21 formed by the plastic material corresponding to the injection opening 122 remains on the chassis 30. The high speed at which the molten plastic material 20 is injected into the mold 10 can be slowed down through forming the sprue 21 during the injection molding process. Accordingly, a turbulence and a formation of material ejector marks or the ring-shaped flow traces formed in the plastic material 20 can be reduced, thereby improving the surface smoothness of the finished chassis 30.

A step S300 is, then, performed to cut off the portion of the chassis 30 corresponding to the injection opening 122 to form the accommodating recess 32. In detail, as shown in FIG. 11 and FIG. 12, the sprue 21 and the portion of the chassis 30 corresponding to the injection opening 122 as shown in FIG. 3 are cut off to form the accommodating recess 32, such that the accommodating recess 32 is connected to the screw hole 31. Therefore, the screw (not shown) can be placed along the direction from the accommodating recess 32 to the screw hole 31. Accordingly, the manufacturing of the chassis 30 can be completed.

According to the mold and the method of manufacturing chassis disclosed by the above embodiments, the core of the mold corresponds to the injection opening configured for the plastic material to be injected into the molding space, and the injection opening can correspond to the screw hole of the finished chassis. That is, a position of the injection opening can be configured as a position of the screw hole of the chassis. Therefore, the presence of the core can assist in generating a disturbance when injecting the plastic material into the molding space, so that the formation of ring-shaped flow traces on the chassis can be reduced. In addition, the plastic material is injected directly through the injection opening configured as the screw hole of the finished chassis without addition injection openings. Accordingly, the aesthetic appearance of the finished chassis can be maintained without additional auxiliary materials to cover up molding traces.

In addition, as mentioned above, the position of the injection opening 122 can be configured as the position of the screw hole of the chassis. Therefore, the times of mold trials for the mold 10 can be reduced, and the time required to adjust injection molding parameters can be shortened. Moreover, even if traces occur due to shrinkage of the injection opening 122 during the injection molding process, such traces can be removed by machining the area of the injection opening 122 into the screw hole through cutting off the sprue formed by the plastic material. Accordingly, the adverse effect on the aesthetic appearance of the finished chassis can be prevented.

It will be apparent to those skilled in the art that various modifications and variations can be made to the present disclosure. It is intended that the specification and examples be considered as exemplary embodiments only, with the scope of the present disclosure being indicated by the following claims.

What is claimed is:

1. A mold, configured for manufacturing a chassis, and the mold comprising:
a male portion, having at least one core; and
a female portion, disposed on the male portion and having at least one injection opening, wherein a molding space is formed between the male portion and the female portion, the at least one injection opening is connected to the molding space, the at least one injection opening is configured for a plastic material to be injected into the molding space, the plastic material can be molded as the chassis, the at least one core is located in the molding space, the at least one core corresponds to the at least one injection opening, and the at least one core is configured to correspond to at least one screw hole which is formed in the chassis after the chassis is demolded from the male portion and the female portion;
wherein after injecting the plastic material through the at least one injection opening to form the chassis, a portion of the chassis corresponding to the at least one injection opening is cut off, then the portion of the chassis can be formed as at least one accommodating recess connected to the at least one screw hole, and a diameter of the at least one screw hole is less than a diameter of the at least one accommodating recess.

2. The mold according to claim 1, wherein a distance between the at least one core and the female portion is equal to an average distance between the male portion and the female portion.

3. The mold according to claim 1, wherein the male portion further has a flat surface, at least one recess portion, at least one bottom surface and at least one surrounding surface, the flat surface faces the female portion, the at least one recess portion recesses inwardly from the flat surface, the at least one bottom surface and the at least one surrounding surface together surround the at least one recess portion, the flat surface and the at least one bottom surface are respectively connected to two opposite sides of the at least one surrounding surface, the at least one core protrudes from the at least one bottom surface, and the at least one core is spaced apart from the at least one surrounding surface.

4. The mold according to claim 3, wherein the female portion further has at least one protrusion, the at least one protrusion is located at the at least one injection opening, the at least one protrusion extends toward the male portion, and the at least one injection opening penetrates through the at least one protrusion.

5. The mold according to claim 4, wherein the at least one protrusion has a first side surface and a second side surface facing away from each other, the first side surface faces away from the at least one injection opening, and a maximum distance between the first side surface and the at least one surrounding surface is equal to an average distance between the male portion and the female portion.

6. A method of manufacturing chassis, comprising:
assembling a male portion and a female portion to form a molding space between the male portion and the female portion;
injecting a plastic material into the molding space from at least one injection opening of the female portion to form a chassis within the molding space; and
cutting off a portion of the chassis corresponding to the at least one injection opening to form at least one accommodating recess;
wherein at least one core of the male portion corresponds to the at least one injection opening and at least one screw hole which is formed in the chassis after the chassis is demolded from the male portion and the female portion, the at least one accommodating recess is connected to the at least one screw hole, and a diameter of the at least one screw hole is less than a diameter of the at least one accommodating recess.

7. The method of manufacturing chassis according to claim 6, wherein a distance between the at least one core and the female portion is equal to an average distance between the male portion and the female portion.

8. The method of manufacturing chassis according to claim 6, wherein the male portion further has a flat surface, at least one recess portion, at least one bottom surface and at least one surrounding surface, the flat surface faces the female portion, the at least one recess portion recesses inwardly from the flat surface, the at least one bottom surface and the at least one surrounding surface together surround the at least one recess portion, the flat surface and the at least one bottom surface are respectively connected to two opposite sides of the at least one surrounding surface, the at least one core protrudes from the at least one bottom surface, and the at least one core is spaced apart from the at least one surrounding surface.

9. The method of manufacturing chassis according to claim 8, wherein the female portion further has at least one protrusion, the at least one protrusion is located at the at least one injection opening, the at least one protrusion extends toward the male portion, and the at least one injection opening penetrates through the at least one protrusion.

10. The method of manufacturing chassis according to claim 9, wherein the at least one protrusion has a first side surface and a second side surface facing away from each other, the first side surface faces away from the at least one injection opening, and a maximum distance between the first side surface and the at least one surrounding surface is equal to an average distance between the male portion and the female portion.
